(19) United States
(12) Patent Application Publication
(10) Pub. No.: US 2014/0021373 A1
(43) Pub. Date: Jan. 23, 2014

(54) BEAMLINE ELECTRODE VOLTAGE MODULATION FOR ION BEAM GLITCH RECOVERY

(71) Applicants: Piotr Lubicki, Peabody, MA (US); Christopher Leavitt, Gloucester, MA (US); Timothy Miller, Ipswich, MA (US); Bon-Woong Koo, Andover, MA (US)

(72) Inventors: Piotr Lubicki, Peabody, MA (US); Christopher Leavitt, Gloucester, MA (US); Timothy Miller, Ipswich, MA (US); Bon-Woong Koo, Andover, MA (US)

(73) Assignee: VARIAN SEMICONDUCTOR EQUIPMENT ASSOCIATES, INC., Gloucester, MA (US)

(21) Appl. No.: 13/555,910

(22) Filed: Jul. 23, 2012

(51) Int. Cl. G21K 5/02

(52) U.S. Cl. 250/492.3

(57) ABSTRACT

An ion implantation system and method are disclosed in which glitches in voltage are minimized by use of a modulated power supply system in the implanter. The modulated power supply system includes a traditional power supply and a control unit associated with each power supply, where the control unit is used to isolate the power supply from an electrode if a glitch or arc is detected. The control unit then restores connectivity after the glitch condition has been rectified.

### FIELD

This invention relates to ion implantation and, more particularly, to uniformity during ion implantation.

### BACKGROUND

Ion implantation is a standard technique for introducing conductivity-altering impurities into a workpiece. A desired impurity material is ionized in an ion source, the ions are accelerated to form an ion beam of prescribed energy, and the ion beam is directed at the surface of the workpiece. The energetic ions in the beam penetrate into the bulk of the workpiece material and are embedded into the crystalline lattice of the workpiece material to form a region of desired conductivity.

Solar cells are one example of a device that uses silicon workpieces. Any reduced cost to the manufacture or production of high-performance solar cells or any efficiency improvement to high-performance solar cells would have a positive impact on the implementation of solar cells worldwide. This will enable the wider availability of this clean energy technology.

There are many different solar cell architectures. Two common designs are the selective emitter (SE) and the interdigitated backside contact (IBC). A SE solar cell has high-dose stripes across the lightly doped surface impinged by sunlight. An IBC solar cell has alternating p-type and n-type stripes across the surface not impinged by sunlight. Both a SE and IBC solar cell may be implanted with ions to dope the various regions.

“Glitches” may occur during the ion implantation process. A glitch is defined as a sudden degradation in the beam quality during an ion implantation operation, typically due to a variation in an operating voltage. Such a glitch is typically caused by interactions between components along the beam path, which affect one or more operating voltages, and can be caused at various locations along the beam path. For example, ion implanters generally employ several electrodes along this beam path, which accelerate the beam, decelerate the beam, or suppress spurious streams of electrons that are generated during operation. Each of these electrodes is maintained at a predetermined voltage. Often, electrodes of different voltage are located near each other and therefore an arc may occur between electrodes. Generally, arcs occur across acceleration gaps, deceleration gaps, or suppression gaps, although arcs may occur elsewhere. Interaction between, for example, a source extraction voltage, source suppression voltage, and source beam current may cause a glitch. These glitches may be detected as a sharp change in the current from one of the power supplies. If the implantation is interrupted or affected by a glitch, the implanted solar cell or other workpiece may be negatively affected or even potentially rendered unusable. For example, a solar cell may have a lower efficiency due to the lower implanted dose caused by a glitch. This may have a cost impact on the implanted workpieces. Thus, steps are usually taken to both minimize the occurrence of such glitches and to recover from the glitches if possible.

FIG. 1 is a chart illustrating a glitch. The beam current is set to a predetermined value 10. The glitch 11 occurs during the period marked Δt outlined by the dotted lines 12, 13 where the beam current drops below the predetermined value 10. A typical glitch may last for a period of about 100 milliseconds. Minimizing the Δt period means that there is less negative impact on the workpiece being implanted. The glitch 11 may be sensed by measuring changes in voltage or current. An arc is typically sensed by either an abrupt voltage collapse, or an abrupt current surge. When a glitch is detected, one solution is to immediately reduce the ion beam current to zero, thus terminating the implantation at a defined location on the workpiece. This is referred to as “blanking the beam”.

FIG. 2 is a chart illustrating blanking an ion beam. At time 100 when the glitch is first detected, the voltage is dropped to zero and then slowly built back up to the desired voltage level by time 101. At time 100, implantation stops as well, and the position of the implantation relative to the workpiece at time 100 is saved. In one instance, the voltage may be blanked for tens of milliseconds before voltage is recovered over the next hundred or more milliseconds. When the voltage recovers within 0.1-0.5% of the desired value, such as at time 101, implantation may continue from the location on the workpiece where it had stopped. Thus, once the glitch condition has been remedied, the implantation process ideally resumes at exactly the same location on the workpiece, with ideally the same beam characteristics as existed when the glitch was detected. The goal is to achieve a uniform doping profile, and this can be achieved by controlling the beam current or the workpiece scan speed (exposure time). However, blanking is time-consuming, which has a negative impact on throughput. For example, the workpiece must be re-positioned to the exact location where the glitch occurred and the ion beam needs to re-started at exactly this location. Decreased throughput also results in higher costs.

Repairing the dose loss caused by the glitch in such a manner may take over 30 seconds, which may be too time-consuming for the throughput demands of the solar cell industry. Ion beam stability and implant uniformity within the ion implanter are controlled by the speed of the voltage and current sources connected to the ion implanter.

Therefore, there is a need in the art for an improved method of glitch recovery during the implantation of workpieces and, more particularly, solar cells.

### SUMMARY

An ion implantation system and method are disclosed in which glitches in voltage are minimized by use of a modulated power supply system in the implanter. The modulated power supply system includes a traditional power supply and a control unit associated with each power supply, where the control unit is used to isolate the power supply from an electrode if a glitch or arc is detected. The control unit then restores connectivity after the glitch condition has been rectified.

### BRIEF DESCRIPTION OF THE DRAWINGS

For a better understanding of the present disclosure, reference is made to the accompanying drawings, which are incorporated herein by reference and in which:

FIG. 1 is a chart illustrating a beam glitch;

FIG. 2 is a chart illustrating blanking an ion beam;

FIG. 3 is a chart comparing dose versus workpiece y-position for beam glitches of various durations;

FIG. 4 is a block diagram of a beam-line ion implanter;

FIG. 5 is a block diagram of a modulated power supply system for use with the beam-line ion implanter of FIG. 4;

FIG. 6 is a timing diagram showing the operation of the modulated power supply system of FIG. 5;

FIG. 7 is a second embodiment where a control unit is used to control multiple electrodes.

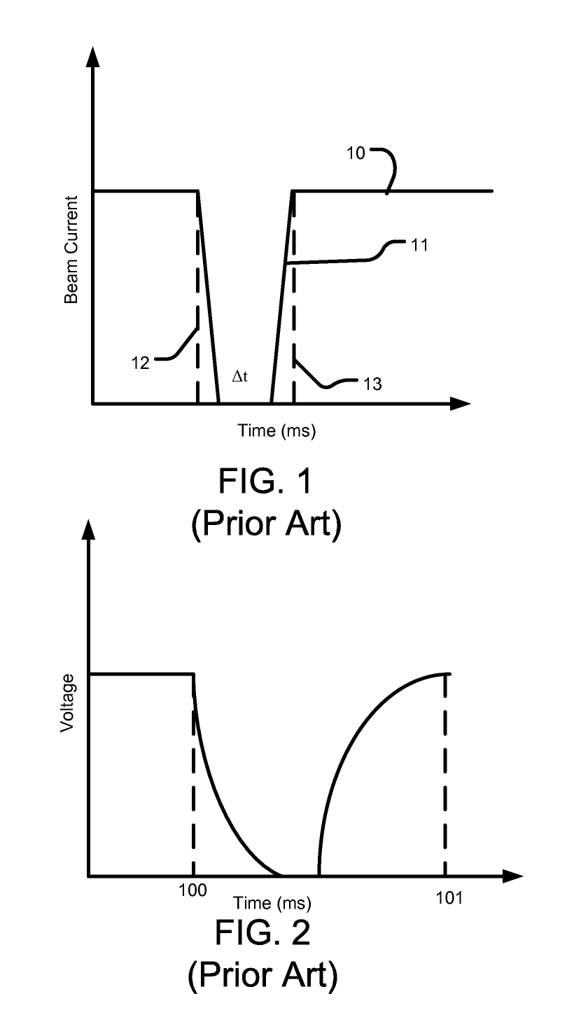

### DETAILED DESCRIPTION

The embodiments of this method are described herein in connection with an ion implanter. Beam-line ion implanters, plasma doping ion implanters, or flood ion implanters may be used. Any n-type and p-type dopants may be used, but the embodiments herein are not limited solely to dopants. Furthermore, embodiments of this process may be applied to many solar cell architectures or even other workpieces such as semiconductor wafers, flat panels, or light emitting diodes (LEDs). Thus, the invention is not limited to the specific embodiments described below.

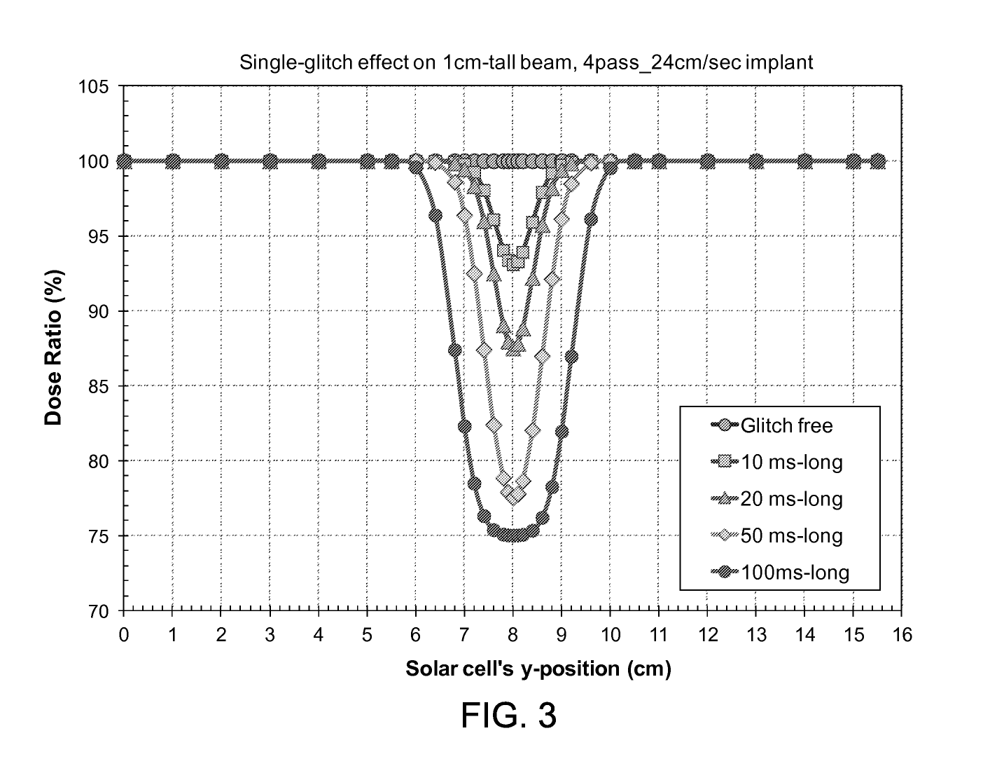

As noted above, glitches may cause non-uniformity of the ion beam or non-uniformity of the implantation of the workpiece. However, the extent of the non-uniformity is related to the duration of the glitch. FIG. 3 is a chart comparing dose versus workpiece y-position for glitches of various durations. FIG. 3 represents an implant that uses four passes through an ion beam using a 24 cm/sec scan rate and assuming that beam height in y-direction is 1 cm. Of course, a uniform dose is desired. Glitches of various durations are modeled, where the glitch occurs as the ion beam was scanning across the workpiece. A glitch of, for example, 50 ms may impact the dose of the workpiece by more than 20% in the region impacted by the glitch. In some embodiments, this degradation may be to an extent that, for example, a solar cell may have reduced efficiency. Smaller time periods may have negligible or acceptable effects on the workpiece. For example, a glitch of 10 ms may only reduce the dose in the affected region by about 6%. Similarly, a glitch of 20 ms may affect the impacted region by about 12%. Thus, if glitches can be reduced to such durations, solar cell efficiency is not substantially impacted and throughput is not compromised because remedial action may not be required.

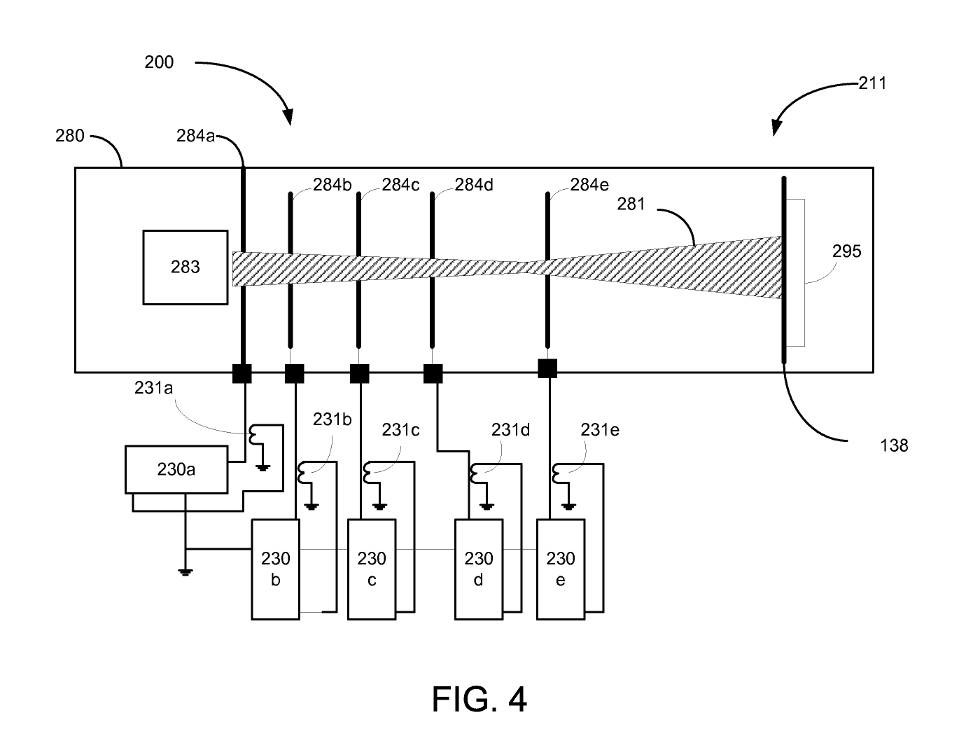

FIG. 4 is a simplified block diagram of a beam-line ion implanter 200. In one instance, this may be for doping a semiconductor or solar cell workpiece. Those skilled in the art will recognize that the beam-line ion implanter 200 is only one of many examples of beam-line ion implanters that can produce ions. Thus, the embodiments disclosed herein are not limited solely to the beam-line ion implanter 200 of FIG. 4.

In general, the beam-line ion implanter 200 includes an ion source 280 to generate ions that form an ion beam 281. The ion source 280 may include an ion chamber 283. A gas is supplied to the ion chamber 283 where the gas is ionized. This gas may be or may include or contain, in some embodiments, hydrogen, helium, other rare gases, oxygen, nitrogen, arsenic, boron, phosphorus, aluminum, indium, antimony, carborane, alkanes, another large molecular compound, or other p-type or n-type dopants. The ions thus generated are extracted from the ion chamber 283 to form the ion beam 281. The ion beam 281 passes through an extraction electrode 284a.

An end station 211 supports one or more workpieces, such as workpiece 138, in the path of ion beam 281 such that ions of the desired species are implanted into workpiece 138. The end station 211 may include a platen 295 to support one or more workpieces 138. The end station 211 also may include a scanner (not shown) for moving the workpiece 138 perpendicular to the long dimension of the ion beam 281 cross-section, thereby distributing ions over the entire surface of workpiece 138. Although the ion beam 281 is illustrated, other embodiments may provide a spot beam. It will be understood to those skilled in the art that the entire path traversed by the ion beam is evacuated during ion implantation. The beam-line ion implanter 200 may include additional components known to those skilled in the art and may incorporate hot or cold implantation of ions in some embodiments.

In the path between the ion source 280 and the workpiece 138, the ion beam 281 passes through various components. These components may include, for example, a suppression electrode, a ground electrode, a mass analyzer and an angle corrector magnet. The mass analyzer may include a resolving magnet and a masking electrode having a resolving aperture. The resolving magnet deflects ions in the ion beam 281 such that ions of a desired ion species may pass through the resolving aperture. Undesired ion species do not pass through the resolving aperture, but may be blocked by the masking electrode. Ions of the desired ion species may pass through the resolving aperture to the angle corrector magnet. The angle corrector magnet may deflect ions of the desired ion species and convert the ion beam from a diverging ion beam to ribbon ion beam, which has substantially parallel ion trajectories. In other embodiments, a mass analyzer or angle corrector magnet is not included in the ion implanter 200. The beam-line ion implanter 200 may further include acceleration or deceleration units in some embodiments.

Some of these components may be at differing voltages, and therefore require power supply systems to provide those voltages. In FIG. 4, five power supply systems 230a-230e are shown, although more or less power supply systems may be included. In this figure, power supply system 230a is used to bias the extraction electrode 284a near the ion chamber 283. Power supply systems 230b-230e may be used to bias other components 284b-284e along the beam line, which may include acceleration or deceleration electrodes, suppression electrodes, resolving magnets, and angle corrector magnets. The components used in the beam-line implanter 200 may vary, and in some embodiments, one or more of the components described above may not be included. Thus, more or fewer than all the components 284b-284e may be included. These power supply systems 230a-230e may be used to provide positive or negative voltages, as required, and the voltages used are not limited by the disclosure. Furthermore, the term “electrode” is used in this disclosure to denote an electrode as well as any component maintained at a voltage different than ground.

In one specific embodiment, only two power supply systems are used. In this embodiment, only three electrodes 284a-284c are used, where electrode 284a is an extraction electrode, electrode 284b is a suppression electrode and electrode 284c is a ground electrode. In this embodiment, one of the power supply systems is used to negatively bias the suppression electrode 284b relative to ground. The extraction power supply system 230a is used to positively bias the ion source 280 relative to ground. There are three specific instances where the glitches may occur. First, the extraction electrode 284a, which is positively biased, may arc to the suppression electrode 284b, which is negatively biased. Second, the suppression electrode 284b, which is negatively biased, may arc to a ground electrode 284c. Lastly, a positively biased extraction electrode 284a may arc to a ground electrode 284c.

In other embodiments, deceleration and acceleration electrodes may also be used in the ion implanter 200, which requires an additional power supply system for each electrode. This also increases the instances where glitches can occur, as there are more power supply systems in the implanter.

The arcing corresponding to a glitch may be sensed by a voltage collapse to a value below the voltage threshold value or a current rise above the current threshold value. By improving arc detection of the voltage sources, it is possible to better control glitch duration. Faster arc detection and voltage recovery may be used to keep glitch durations below 1 ms. This allows a workpiece to be implanted to within 6% of the desired dose, which may be acceptable for workpieces such as solar cells.

As described above, glitches of sufficiently short duration may not impact the efficiency of a solar cell and will not reduce the manufacturing throughput. Thus, it is desirable to reduce glitches is about 1 ms. Most currently available high voltage power supplies have slow arc detection and very slow recovery. In fact, in some embodiments, a power supply may take hundreds of milliseconds to return to its nominal value after a glitch.

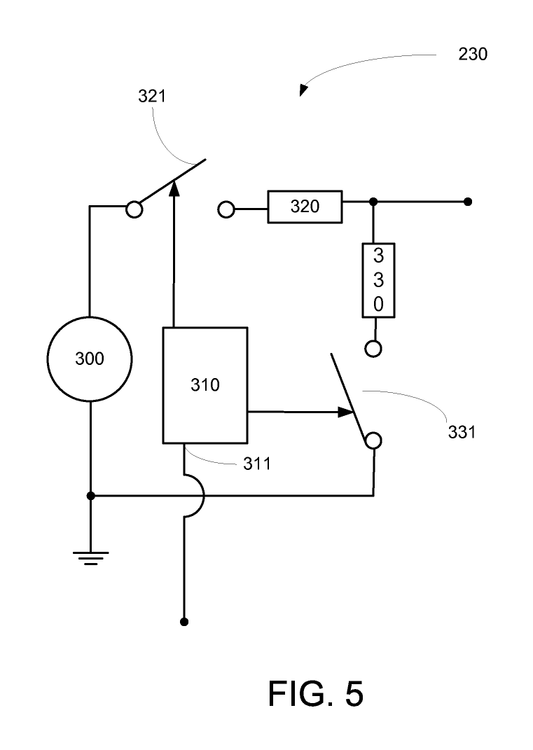

FIG. 5 shows a block diagram of a modulated power supply system 230 used in the beam-line implanter 200 of FIG. 4 or some other implanter. The modulated power supply system 230 includes a high voltage power supply 300. Any suitable high voltage power supply may be used. One terminal of the power supply 300 is typically grounded, while the opposite terminal is electrically connected to one terminal of source switch 321. The source switch 321 and discharge switch 331 may be any suitable switch, such as a solid-state power semiconductor-based switch, such as a MOSFET, IGBT, IGCT device. Additionally, other switches, including but not limited to vacuum tubes or triodes may also be used. The second terminal of source switch 321 is electrically connected to one terminal of a source impedance 320. The second terminal of the source impedance 320 is electrically connected to an electrode (such as one of the electrodes 284a-284e in FIG. 4). The second terminal of the source impedance 320 is also electrically connected to one terminal of the discharge impedance 330. The second terminal of the discharge impedance 330 is electrically connected to one terminal of discharge switch 331. The second terminal of discharge switch 331 is electrically connected to ground. The source switch 321 and the discharge switch 331 may be fast switching components, having sub-microsecond on and off times. Because of this, the source switch 321 and discharge switch 331 may experience high value peak currents during switching operations. Therefore, source impedance 320 and discharge impedance 330 may be used to limit the amount of current that passes through the source switch 321 and the discharge switch 331, respectively. The source impedance 320 and discharge impedance 330 may include an inductive element to limit the flow of current. In other embodiments, a source impedance 320 and a discharge impedance 330 are not used. In this embodiment, the second terminal of the source switch 321 is electrically connected directly to an electrode (such as one of the electrodes 284a-284e in FIG. 4). Similarly, the first terminal of the discharge switch 331 is electrical connected directly to the second terminal of the source switch 321.

The source switch 321 and the discharge switch 331 are actuated by a control unit 310. The control unit 310 may be any processing unit, such as a microprocessor, microcontroller, or special purpose computing device. The control unit 310 may have an associated storage element. The storage element contains the computer readable instructions necessary to implement the algorithms and routines described herein. In addition, the control unit 310 also has at least one input 311, which is used to detect glitches or arcs associated with the power supply 300. In some embodiments, the input 311 is an analog input, such that the input signal represents the current sourced by the power supply 300. For example, FIG. 4 shows a current monitor 231a-231e associated with each modulated power supply system 230a-230e, such that the current monitor 231a-231e measures the current used to power the respective electrode or component 284a-284e. In other embodiments, the input 311 is an analog input, which is a voltage that has a known relationship to the voltage applied to the electrode or component 284a-284e. In yet other embodiments, the input 311 may be a digital signal, such as a serial interface that receives an encoded value. In yet other embodiments, a comparator is used outside of the control unit 300, such that the input 311 is a binary indication of whether the current or voltage is within the desired range. In this embodiment, the control unit 310 may have an output that is used by the comparator to set the threshold value.

In each of these embodiments, the control unit 310 monitors the input 311 and determines whether it is within a predetermined range. In the case of a current monitor 231, the control unit 310 may set an allowable range, such that any value outside this range is considered to be a glitch. In some embodiments, this range has both positive and negative thresholds, as current may flow in either direction depending on the polarity of the arc or glitch.

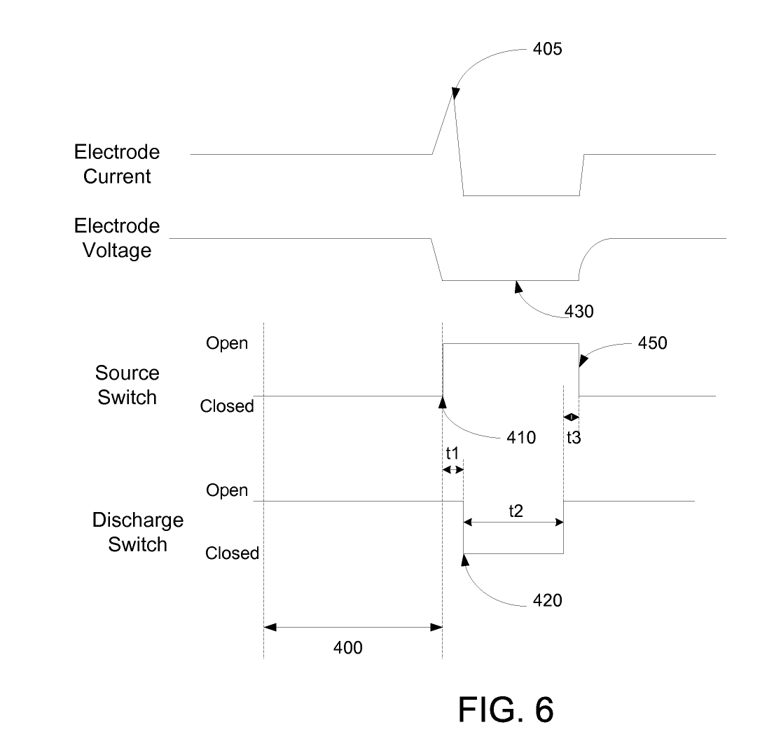

FIG. 6 shows a timing diagram illustrating the following timing sequence. The control unit 310 in FIG. 5 continuously monitors the input 311. If the input 311 is within a predetermined range, the source switch 321 remains closed and the discharge switch 331 remains open, as shown during time period 400 of FIG. 6. This electrically connects the power supply 300 to the electrode or component 284a-284e of FIG. 4. If the input 311 in FIG. 5 deviates from this range, such as due to a glitch 405 shown in FIG. 6, the control unit 310 actuates source switch 321, causing it to open at time 410. This isolates the power supply 300 from the electrode or other component that is experiencing the glitch. After a first delay period, t1, the control unit 310 then closes discharge switch 331 at time 420. This allows any charge that exists on the electrode or other component to be quickly dissipated. As a result, the voltage on the electrode becomes 0 volts, as shown at time 430. The removal of charge from the electrode or other component may also serve to eliminate the cause of the arc or glitch. After a second time period, t2, the control opens the discharge switch 331 at time 440, thereby isolating the electrode or component from ground. The second time period, t2, defines the blanking time for the system. After a third time period, t3, the source switch 321 is closed by the control unit 310 at time 450 and power is thus restored to the electrode 284a-e. Over time, the electrode returns to its desired voltage. The times t1 and t3 may be small relative to t2. For example, the sum of t1 and t3 may be in the range of a few microseconds, while t2 may be hundreds of microseconds to several milliseconds.

Thus, the control unit 310, through the use of programmable parameters in the storage element, can be configured to control a number of parameters. These parameters include the threshold value at which a glitch is detected. By adjusting this threshold, faster glitch detection can be achieved. In addition, the time between the opening of the source switch 321 and the closing of discharge switch 331 (i.e. t1) may be controlled by the control unit 310, if desired. Similarly, the time between the opening of the discharge switch 331 and the source switch 321 (i.e. t3) may be controlled by the control unit 310. For example, the time periods, t1 and t3, may be selected based on the switching characteristics of the source switch 321 and the discharge switch 331. It should be noted that, in some embodiments, the source switch 321 and discharge switch 331 may be configured such that a single output from the control unit 310 may be used to simultaneously control both switches. For example, one of the switches may be an N-channel MOSFET, while the other is a P-channel MOSFET. A single output from the control unit 310 can then be used to actuate both switches simultaneously. The control unit 310 can also be programmed with various blanking times, which is the time during which the discharge switch 331 is closed. In some embodiments, the blanking time may be as short as tens or hundreds of microseconds. In other embodiments, the blanking time may be several milliseconds. The blanking time may be adjusted based on the energy stored in the system and thus, the time required to discharge this stored energy. It may also be adjusted depending on process requirements, such as required uniformity. This time may be implementation specific, and no restrictions are placed on these values. In some embodiments, the blanking times may be as short as about 100 microseconds for certain applications. In other embodiments, longer blanking times, such as several milliseconds, may be acceptable.

In some embodiments, the blanking time may be shorter than the recovery time of the power supply 300. In other words, after a glitch, the power supply 300 may require some time, often in the millisecond range, to reestablish a regulated output. It is therefore beneficial if the power supply 300 used has a large output capacitance, such that the stored energy can control the droop that can occur after the source switch 321 is closed. If the output capacitance is smaller, the blanking time may be shortened to minimize droop and the process may be repeated multiple times to eliminate the stored energy.

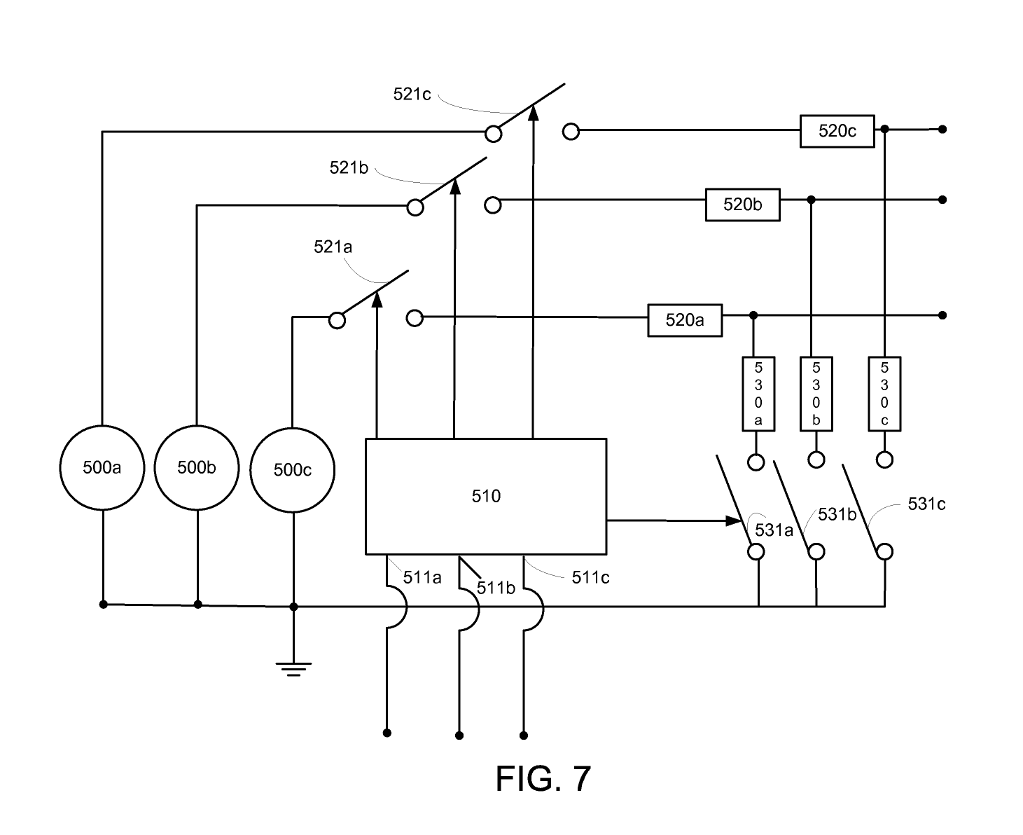

In some embodiments, each modulated power supply system 230 has a dedicated control unit 310, which is used to control the source switch 321 and discharge switch 331 for a respective power supply 330. However, as shown in FIG. 7, in other embodiments, the control unit 510 is shared among a plurality of power supplies 500a-500c and switches. For example, as shown in FIG. 7, a single control unit 510 may be used to receive inputs 511a-511c from each electrode and may control source switches 521a-521c and discharge switches 531a-531c associated with each of these respective electrodes. As before, source impedances 520a-520c and discharge impedances 530a-530c may also be used. While FIG. 7 shows the use of a single control unit 510 with three electrodes, it should be understood that the disclosure is not limited to any particular number of switches or control units. The control unit 510 has visibility to multiple electrodes. Therefore, if desired, in one embodiment, the control unit 510 can be programmed to isolate only the power supply 500 associated with the glitch. In other embodiments, the control unit 510 may isolate all of the power supplies 500a-500c upon detection of a glitch on any of the electrodes.

The use of a modulated power supply system allows a high throughput method of manufacturing semiconductors, where exact dose uniformity is not a requirement, such as solar cells. In such an embodiment, a workpiece is placed on the platen 295. Ions are then directed toward the workpiece by energizing the various components of the ion implantation system. The use of the modulated power supply systems serves to minimize the duration of any glitches, thus helping to maintain the dose uniformity to within about 1%. In some embodiment, a supervisory controller (not shown) monitors the beam current being directed at the workpiece. As long as the dips in the beam current are within a certain limit, such as 0.5-3%, preferably 1%, the dose uniformity is acceptable, and the ion implantation is allowed to continue. Dips greater than this may cause an unacceptable change in dose, rendering the workpiece ineffective as a solar cell. In this case, the scanning of the workpiece is stopped, while the beam current is restored to its nominal level.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An ion implantation system, comprising
an ion source;
an electrode, maintained at a voltage different than ground potential; and
a modulated power supply system in communication with said electrode, wherein said modulated power supply system comprises:
a power supply having a first terminal and a second terminal;
a source switch, having a first terminal electrically connected to said second terminal of said power supply and a second terminal electrically connected to said electrode;
a discharge switch having a first terminal electrically connected to ground and a second terminal electrically connected to said electrode; and
a control unit configured to actuate said source switch and said discharge switch, so as to electrically connect said electrode to ground for a predetermined period of time in response to the detection of a glitch.

2. The ion implantation system of claim 1, wherein said control unit comprises an input representative of a current passing from said power supply.

3. The ion implantation system of claim 2, wherein said control unit compares said input to a predetermined range to detect said glitch.

4. The ion implantation system of claim 1, wherein said control unit opens said source switch to isolate said power supply from said electrode if said glitch is detected.

5. The ion implantation system of claim 4, wherein said control unit closes said discharge switch after opening said source switch.

6. The ion implantation system of claim 1, further comprising a source impedance electrically in series between said electrode and said second terminal of said source switch.

7. The ion implantation system of claim 1, further comprising a discharge impedance electrically in series between said electrode and said second terminal of said discharge switch.

8. The ion implantation system of claim 4, wherein said control unit closes said discharge switch simultaneous with opening said source switch.

9. The ion implantation system of claim 1, wherein said electrode comprises one selected from the group consisting of an extraction electrode and a suppression electrode.

10. The method of minimizing glitches in an ion implantation system, having at least one electrode maintained at a voltage different than ground potential, comprising:
supplying current to said electrode using a power supply;
monitoring said current used to maintain said electrode at said voltage;
detecting a glitch when said monitored current is outside a predetermined range;
electrically isolating said power supply from said electrode and
electrically connecting said electrode to ground in response to said detection of said glitch;
electrically isolating said electrode from ground after a predetermined period of time; and
electrically connecting said electrode to said power supply after said predetermined period of time, thereby restoring power to said electrode.

11. The method of claim 10, wherein a control unit is provided and said control unit performs said monitoring and said detecting.

12. The method of claim 11, wherein a source switch is provided to electrically connect said power supply and said electrode, and said control unit actuates said source switch.

13. The method of claim 11, wherein a discharge switch is provided to electrically connect ground and said electrode, and said control unit actuates said discharge switch.
